(19) United States
(12) Patent Application Publication
(10) Pub. No.: US 2002/0191591 A1
(43) Pub. Date: Dec. 19, 2002

(54) Transmission of connection setup parameters in packet data network

(76) Inventors: Jukka Kivijarvi, Lempaala (FI); Hannu Pirila, Littoinen (FI)

Correspondence Address: PERMAN & GREEN, 425 POST ROAD, FAIRFIELD, CT, 06824, US

(21) Appl. No.: 10/157,377

(22) Filed: May 28, 2002

(30) Foreign Application Priority Data
May 28, 2001 (FI) 20011111
Jun. 13, 2001 (FI) 20011259

(51) Int. Cl. H04L 12/66

(52) U.S. Cl. 370/352; 370/329

(57) ABSTRACT

A method for transmitting connection setup parameters of a packet data network on broadcast control channels in a telecommunication system, which comprises at least one cell which uses a circuit-switched and a packet-switched broadcast/common control channel. At least one mobile station supports the packet data network, the mobile station being arranged to listen to at least one of said broadcast/common control channels. The connection setup parameters of the packet data network are transmitted to mobile stations in the cell on both broadcast control channels if the cell supports the transmission of the connection setup parameters of the packet data network on both broadcast control channels. The mobile station transmits a DCCM indication to the packet data network if the mobile station is able to receive control messages on both common control channels, and the telecommunication system is controlled to transmit control messages to the mobile station on one common control channel.

### FIELD OF THE INVENTION

The invention relates to packet data services of wireless telecommunication systems, and in particular, to transmitting connection setup parameters on broadcast control channels.

### BACKGROUND OF THE INVENTION

The progress in wireless data transmission has more and more brought forth the need to transmit wireless not only calls but also various data applications. However, circuit-switched connections conventionally used in mobile systems are rather poorly suited for the transmission of various burst-type data services, and therefore packet-switched applications have also been developed for the mobile systems. For instance, during the past few years, the European Telecommunication Standards Institute ETSI has drafted for the European digital GSM (Global System for Mobile communication) network GSM 2+ phase standards, in which a new General Packet Radio Service GPRS is also defined. GPRS is a packet-switched radio network utilizing the GSM network, which endeavours to optimize data packet transmission by means of GPRS protocol layers on an air interface between a mobile station and the GPRS network.

The GSM system comprises a plurality of various, typically unidirectional control channels, by means of which the network controls the operation of mobile stations. One such channel is a broadcast control channel BCCH, through which is transmitted information on various cells of the network, such as cell identification data, network identification data, frequencies employed in the cell, etc. Each base transceiver station BTS transmits information on the cell on a broadcast control channel of its own, to which all the mobile stations located in the cell coverage area listen.

Correspondingly, specific control channels have also been designed for the GPRS system, one of which is a packet broadcast control channel PBCCH, whose function is to convey system information to all GPRS mobile stations in the cell; in other words, in a corresponding manner as BCCH does in the GSM network. As a GPRS mobile station is in idle mode, no data transmission resources on traffic channels have been allocated to it, and it only listens to the cell's broadcast control channel BCCH and paging control channel PCH, or packet broadcast control channel PBCCH and packet paging control channel PPCH, if the cell supports this GPRS control channel. If this PBCCH channel is not supported in said cell, which will be very common at a stage when GPRS networks will be built on top of the GSM network, the GPRS mobile station listens to the GSM broadcast control channel BCCH. Thus, the broadcast control channel to be used, PBCCH or BCCH, is defined according to the broadcast control channel available at a given time in the cell of the GPRS mobile station.

Thus, the GPRS mobile station should support broadcast control channel reception on both PBCCH and BCCH. In that case, if PBCCH is available in the cell, the network transmits parameters to be used in the GPRS network to the mobile stations on said PBCCH only.

The above-described arrangement has a problem that if the GPRS mobile station is not able to receive correctly system information transmitted on PBCCH, it is not able to transmit or receive data packet transmissions according to GPRS either. In the near future, when the GSM networks will be updated such that they also support GPRS packet data service, there will be a great risk that the GPRS mobile stations introduced into the market prior to providing the networks with PBCCH will not work on future PBCCH channels of the networks, because it has not been possible to test them in field conditions. Thus, there is also a great risk that the GPRS mobile stations introduced into the market prior to the launching of the GPRS service will not work in the GPRS network either, after the PBCCH channels are put to use in the new networks. This also results in a considerable disadvantage that these GPRS mobile stations will not work with circuit-switched voice services either.

### BRIEF DESCRIPTION OF THE INVENTION

The object of the invention is thus to provide a method and equipment implementing the method such that the above-mentioned problems can be solved. This is achieved with the method and system, which are characterized by what is disclosed in the independent claims. The preferred embodiments of the invention are disclosed in the dependent claims.

The invention is based on the idea that if a cell supports a GPRS service on both BCCH and PBCCH channels, the network is configured to transmit parameters required in a GPRS connection to the GPRS mobile stations on both broadcast control channels. Thus, GPRS mobile stations that do not work on PBCCH channels built for the network, continue to receive broadcast channel only on the BCCH channel and paging messages on the PCH channel, and obtain therefrom the parameters required for using the GPRS service, irrespective of the fact that the cell may simultaneously employ a packet broadcast control channel PBCCH as well.

One alternative embodiment of the invention, in turn, is based on the idea that, in all the cells of the network, parameters required for the GPRS connection are transmitted on a circuit-switched broadcast control channel BCCH to those mobile stations who are able to receive the parameters either on both channels or only on the circuit-switched broadcast channel. These mobile stations then receive the parameters required for using the GPRS service on the broadcast control channel BCCH. Correspondingly, the GPRS mobile stations to be developed in the future and operating according to the standard will receive broadcast channel only on PBCCH and obtain the parameters therefrom.

Further, one alternative embodiment of the invention is based on the idea that in a case where the network only supports packet-switched broadcast /common control channels or circuit-switched broadcast/common control channels, but is not capable of supporting both channels simultaneously such that the network could interpret a correct paging for each mobile station, the mobile station temporarily cancels its packet-switched characteristics and receives only circuit-switched services. Thus, it is possible to ensure that the mobile station is able to use at least circuit-switched voice services, irrespective of which broadcast/common control channels the network supports.

However, the above-described case, in which the GPRS connection setup parameters are transmitted on both broadcast control channels and which can be referred to as a dual control channel mode DCCM, causes an additional problem in that the network should be able to determine other control channels, in particular the common control channel, used by each mobile station, in order that all control commands required for using the GPRS service could be conveyed correctly.

This additional problem is solved such that the GPRS mobile station, located in the DCCH cell and supporting the DCCH mode, indicates separately to the network, upon receiving the connection setup parameters, which one of the common channels, the circuit-switched or the packet-switched channel, it is able to use, in response to which the network can allocate suitable traffic and common control channels to each mobile station, and correspondingly, convey the control messages on correct channels.

The method and system of the invention have an advantage that it is possible to ensure that the GPRS mobile stations, introduced into the market prior to launching the GPRS services, will work in the cells where the PBCCH channel is used. A further advantage is that it is also possible to ensure that the GPRS mobile stations to be developed in the future will also be able to receive broadcast control channel on PBCCH. Yet another advantage is that mobile stations employing circuit-switched common control channels and packet-switched common control channels can be readily separated onto different traffic channels, which makes sure that those operating on circuit-switched common control channels do not receive control messages belonging to packet-switched control channels.

### BRIEF DESCRIPTION OF THE DRAWINGS

In the following, the invention will be described in greater detail in connection with preferred embodiments, with reference to the attached drawings, wherein

FIG. 1 is a block diagram of the structure of a GSM/GPRS system;

FIG. 2 illustrates a message according to a preferred embodiment of the invention;

FIG. 3 is a block diagram of substantial network elements of one embodiment of the invention;

FIG. 4 illustrates a message according to one preferred embodiment of the invention.

### DETAILED DESCRIPTION OF THE INVENTION

In the following, the invention will be described by way of example based on the GSM/GPRS system. However, the invention is not restricted only to the GSM/GPRS system, but it can also be applied e.g. to what is known as the third generation mobile system UMTS (Universal Mobile Telecommunication System), which comprises functions corresponding to those of the GPRS system and whose mobile stations should also support data transmission of the GSM/GPRS system.

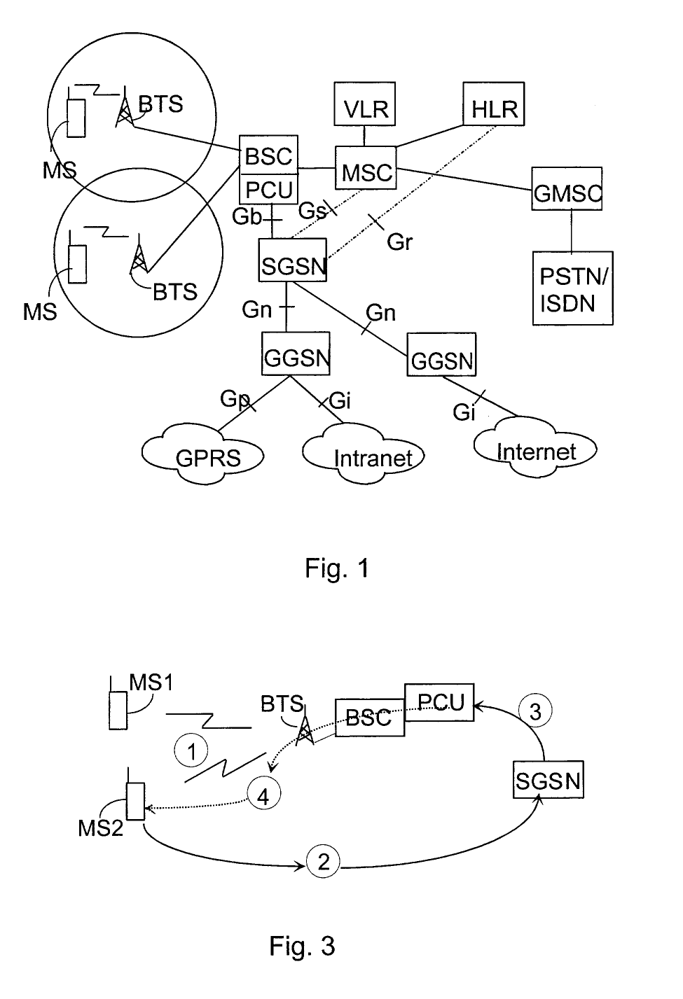

FIG. 1 illustrates how the GPRS system is built on the GSM system. The GSM system comprises mobile stations MS that communicate over radio path with base transceiver stations BTS. A plurality of base transceiver stations BTS are connected to a base station controller BSC that controls radio frequencies and channels available to said base transceiver stations. The base station controller BSC and the related base transceiver stations BTS constitute a base station subsystem BSS. The base station controllers BSC, in turn, communicate with a mobile services switching center MSC, which takes care of connection establishment and call routing to correct addresses. Two databases containing information on mobile subscribers are used for this purpose: a home location register HLR, which comprises data on all subscribers of the mobile network and services they subscribe to, and a visitor location register VLR, which comprises data on mobile stations visiting the service area of a particular mobile services switching center MSC. The mobile services switching center MSC, in turn, communicates with other mobile services switching centers through a gateway mobile services switching center GMSC and with a public switched telephone network PSTN. For a more detailed description of the GSM system, reference is made to the ETSI/GSM specifications and to The GSM system for Mobile Communications, M. Mouly and M. Pautet, Palaiseau; France, 1992, ISBN:2-957190-07-7.

The GPRS system connected to the GSM network comprises two nearly independent functions, i.e. a gateway GPRS support node GGSN and a serving GPRS support node SGSN. The GPRS network may comprise a plurality of gateway and serving support nodes, and typically a plurality of serving GPRS support nodes SGSN are connected to one gateway GPRS support node GGSN. Both nodes SGSN and GGSN act as routers which support the mobility of the mobile station and control the mobile system and route the data packets to the mobile stations, irrespective of their location and the protocol used. The serving GPRS support node SGSN communicates with the mobile station MS via the mobile network. A connection to the mobile network (interface Gb) is typically established via a base station controller BSC, which typically comprises a packet control unit PCU, by means of which the function required by the interface Gb is provided in the base station controller BSC, and the forwarding of data packets from the base station controller onwards is controlled. The task of the serving GPRS support node SGSN is to detect the mobile stations capable of GPRS connections in its service area, to transmit data packets to and receive them from said mobile stations, and to monitor the location of the mobile stations in its service area. Thus, user data of all GPRS mobile stations located in the service area of the serving GPRS support node SGSN passes through said serving support node. The serving GPRS support node SGSN also communicates with a short message service center SMS-GMSC of incoming short messages via an interface Gd and with the home location register HLR via an interface Gr, and possibly also with the mobile services switching center MSC and the visitor location register VLR via a signaling interface Gs. GPRS records that comprise the contents of the subscriber-specific packet data protocols are also stored in the home location register HLR.

The gateway GPRS support node GGSN acts as a gateway between the GPRS network and an external packet data network PDN. External packet data networks include e.g. the GPRS network of another network operator or the Internet. The gateway GPRS support node GGSN communicates with said data networks via interfaces Gp (another GPRS network) and Gi (other PDNs). Private local area networks are typically connected via a router to any one of said data networks. The data packets transferred between GGSN and SGSN are always encapsulated according to the GPRS standard. The gateway GPRS support node GGSN also contains the GPRS mobile stations' PDP (Packet Data Protocol) addresses and routing data, i.e. SGSN addresses. Thus, the routing data is used for linking the data packets between an external data network and the serving GPRS support node SGSN. The GPRS backbone network between the gateway GPRS support node GGSN and the serving GPRS support node SGSN is a network utilizing the IP protocol, either IPv4 or IPv6 (Internet Protocol, version 4/6).

The GSM system comprises a plurality of various, typically unidirectional control channels, by means of which the network controls the operation of the mobile stations. One of these is a broadcast control channel BCCH, through which information is transmitted on different cells of the network, such as cell identification data, network identification data, frequencies used in the cell, etc. Each base transceiver station BTS transmits the cell data on its own broadcast channel, to which all the mobile stations in the service area of the cell listen. A further control channel is a common control channel CCCH. CCCH can be divided into three logical channels: a paging channel PCH, an access grant channel AGCH and a random access channel RACH. Paging messages to mobile stations, for instance in connection with a call setup initiated by the network, are transmitted on the paging channel PCH, and on the access grant channel AGCH the base transceiver station allocates to the mobile station an SDCCH channel for allocating a traffic channel to be used for the call. The paging channel PCH and the access grant channel AGCH have similar structures, and they are used alternately according to a specific scheme, but never simultaneously. To said control channels are allocated time-division frames from the same control channel superframe structure they have in common with other control channels. The different control channels are thus multiplexed into this control channel superframe structure in specific channel combinations.

Correspondingly, a particular packet broadcast control channel PBCCH and a particular packet common control channel PCCCH have been determined for the GPRS system. The task of the packet broadcast control channel PBCCH is to convey system information to all GPRS mobile stations in the cell. The packet common control channel PCCCH comprises, like the GSM common control channel CCCH, a plurality of logical control channels. In downlink (from base station to mobile station), these control channels include a packet paging channel PPCH, a packet access grant channel PAGCH and a packet notification channel PNCH, and in uplink (from mobile station to base station), a packet random access channel PRACH. The packet paging channel PPCH is used for sending paging messages to mobile stations prior to starting data packet transfer, if the location of the mobile station is not known with an accuracy of a cell. On the packet access grant channel PAGCH, available channel resources are allocated to the mobile station, prior to starting the data packet transfer. The packet notification channel PNCH is used for allocating resources to a PTM (point-to-multipoint) message prior to sending the PTM message to a specific GPRS mobile station group.

When the GPRS mobile station is in packet-idle mode, no data transmission resources are allocated to it on the traffic channels, and it only listens to the cell's packet broadcast control channel PBCCH and packet paging channel PPCH, if the cell supports these GPRS control channels. If said cell does not support these GPRS control channels, said mobile station listens to the GSM control channels BCCH and PCH. Thus, the broadcast control channel to be used, PBCCH or BCCH, is defined according to which broadcast channel is in use in the cell of the GPRS mobile station.

If PBCCH is employed, the network transmits PSI (Packet System Information) messages on the PBCCH channel at regular intervals, which messages the GPRS mobile station regularly picks up. The PBCCH channel employs various types of PSI messages, such as 1, 2, 3, 3 bis, 4 and 5. It is also possible to send a PSI1 message on PBCCH. From the PSI messages of PBCCH the mobile station MS can conclude whether it is able to set up a packet data link in said cell and which parameters it must use for establishing the connection and operating in the cell. The most important of these messages is the PS11 message, by which the network notifies what the situation is regarding the support of packet data services and how the PSI messages to be sent are sequenced. The PS11 message comprises parameters PBCCH_CHANGE_MARK and PSI_CHANGE_FIELD, by means of which it is possible to update changes in the content of and deletions/additions to the PSI messages such that by increasing the parameter values in connection with the changes the mobile stations are controlled to update the changed PBCCH values from the network. Thus, it is also possible to force all the mobile stations in the cell to update their PBCCH data at the same time.

The broadcast control channel BCCH can be used, when PBCCH is not available in the cell in question or when it is necessary to ensure a connection to the network in such a case that PBCCH is removed, for one reason or the other, or its location in the cell changes. A mobile station then listens to SI (system information) messages on the BCCH channel at regular intervals, and especially to the SI13 message which enables the transmission of the necessary GPRS parameters to mobile stations. The parameters are then transmitted that are required for setting up a GPRS connection in a cell which has no PBCCH channel. If the cell in question does not support PBCCH, it is possible to update the changes occurred in the content of the SI messages by means of the parameter BCCH_CHANGE_MARK in the SI13 message and to force all mobile stations in the cell to update their BCCH information at the same time.

A GPRS mobile station should thus support broadcast control channel reception on both the PBCCH channel and the BCCH channel. In accordance with the above, if the cell uses the PBCCH channel, the network transmits the parameters to be used in a GPRS connection to the mobile stations only on said PBCCH channel. On the other hand, if the GPRS mobile station cannot receive correctly system information transmitted on the PBCCH channel, neither can it transmit or receive a data packet transmission according to GPRS. In such a case, using voice services may also be prevented. When the updating of GSM networks is started in the near future so as to make them also support the GPRS packet data service, but only on the BCCH and CCCH channels, a very high risk exists that GPRS mobile stations which came out on the market at an early stage of the GPRS service will not work on the PBCCH channels to be built later into the network, since it has not been possible to test them in field conditions.

This can be avoided in such a manner that if a cell supports the GPRS service on both the BCCH channel and the PBCCH channel, the network is directed to transmit the parameters needed for a GPRS connection to GPRS mobile stations on both broadcast control channels. The GPRS mobile stations which do not work on PBCCH channels to be built in the network then continue broadcast control channel reception on the BCCH channel only and paging message reception on the PCH channel, and through them obtain the parameters required for using the GPRS service in spite of the fact that the cell may simultaneously also use the packet broadcast control channel PBCCH. All parameters related to the GPRS service are transmitted on the BCCH channel as if the PBCCH channel was not at all in use. On the other hand, the GPRS mobile stations to be developed later will also be capable of broadcast control channel reception on the PBCCH channel and packet paging message reception on the PPCH channel. This characteristic, in which the network is capable of transmitting control commands related to connection setup parameters of a packet data service on both circuit-switched and packet-switched control channels can be referred to by the term DCCM (dual control channel mode), for instance. This way, the PBCCH channels can be taken into use in GPRS networks as soon as network manufacturers can supply them, while at the same time making sure that that the GPRS mobile stations currently on the market still work. The mobile stations which can change over to receiving the connection set-up parameters of a packet data service on the PBCCH channel, even though the network also transmits them on the BCCH channel, and change over to listening to the PPCH channel, can be called DCCM mobile stations. Mobile network cells in which the parameters related to the GPRS service are transmitted on both the BCCH channel and the PBCCH channel, can correspondingly be called DCCM cells.

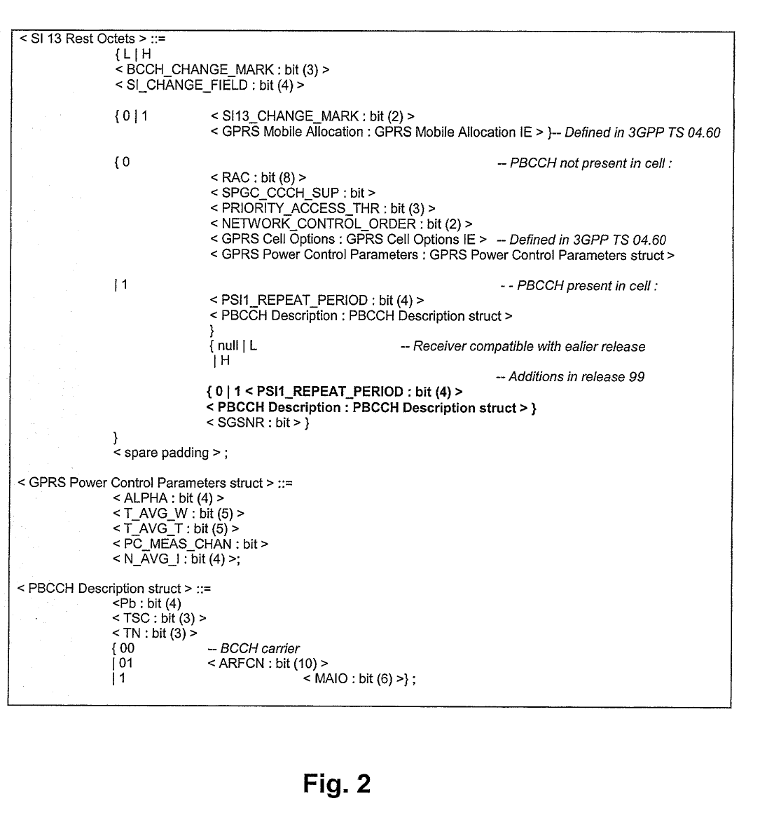

According to a preferred embodiment of the invention, this DCCM function can be implemented by means of the SI13 message transmitted on the BCCH channel. As shown in FIG. 2, the SI13 message comprises first a 3-bit BCCH_CHANGE_MARK field and after it a 4-bit SI_CHANGE_FIELD field. The next bit indicates whether an SI13 _CHANGE_MARK field and channel allocation information (GPRS mobile allocation) are transmitted in this message. The next bit is used to indicate the broadcast control channels supported by the cell. The bit value 0 then indicates that the cell does not use the packet broadcast control channel PBCCH and the GPRS parameters are only transmitted on the BCCH channel by means of the information fields RAC, SPGC_CCCH_SUP, PRIORITY_ACCESS_THR, NETWORK_CONTROL_ORDER, GPRS Cell Options and GPRS Power Control Parameters. The operation of these information fields is not, however, essential for the implementation of the invention and they are described in greater detail in the document 3GPP TS 04.18, V8.9.0, paragraph 10.5.2.37b “SI 13 Rest Octets.”

The bit value 1 is used to indicate that the GPRS parameters are transmitted in the cell on PBCCH channel only. The parameters are transmitted by defining the repetition period of the PSI1 message and the structure of the PBCCH channel used.

Supporting the DCCM operating mode of a cell, in other words, transmitting the GPRS parameters on both the BCCH channel and the PBCCH channel, can now be arranged by first setting the value of said bit to zero, which indicates that the GPRS parameters are transmitted on the BCCH channel. In addition to this, a new data structure (marked in bold in FIG. 2) is added to the extension part of the message, the data structure being one that only the GPRS mobile stations which will come out on the market later on can read and in which the network transmits the PBCCH parameters, i.e. information that the PBCCHIPCCCH channels are also in use in the cell in question, and information on where the PBCCH channel can be found. Such GPRS mobile stations that do not work on the PBCCH channels to be built into the network then perform broadcast control channel reception on the BCCH channel only and listen to paging messages on the PCH channel in spite of the fact that the cell also uses the packet broadcast control channel PBCCH simultaneously. This means that network operators can take PBCCH channels into use in GPRS networks as soon as network manufacturers can supply them.

Thus, by modifying the content of the SI13 message described above, a network operator can separately define the use of the BCCH and PBCCH broadcast control channels in transmitting the GPRS parameters. In the future, when the network operator is convinced that substantially all mobile stations in the network operate on the PBCCH channels, the GPRS parameters can then be transmitted on the PBCCH channel only.

The above-described allocation of broadcast control channels should be taken into account when other control channels, in particular the paging channel PCH or PCCH, are defined. Thus, the GPRS mobile station must be able to indicate to the network, which common control channel, CCCH or PCCCH, it uses for receiving paging messages. This can take place such that the GPRS mobile station supporting the DCCM mode informs the network separately of its DCCM compatibility and on the basis of this information the network is controlled to transmit the control messages on the PCCCH channel. If no information on the DCCM compatibility or mere PCCCH compatibility is received from the mobile station, the control messages will be transmitted to the mobile station in question using the CCCH as a default channel.

According to one preferred embodiment the paging channels are indicated to the network by means of an arrangement of FIG. 3. FIG. 3 shows only those parts of the GSM/GPRS network of FIG. 1 that are substantial to this embodiment. The base transceiver station BTS transmits the above-described SI13 message to the mobile stations MS1 and MS2 (step 1). MS1 does not support the PBCCH/PCCCH channels, so having received the SI13 message it continues listening to the control channels on the BCCH/CCCH channels. Instead, MS2 supports the DCCM operating mode, i.e. in addition to the BCCH/CCCH channels also PBCCH/PCCCH channels, and consequently it is able to decode the above-described SI13 message, and on the basis of said SI13 message, MS2 sets to listen to the PBCCH/PCCCH control channels. The mobile station MS2 can indicate the DCCM operating mode to the network, for instance in an MS RAC (Mobile Station Radio Access Capability) message which is sent in connection with a GPRS Attach process preceding the packet data connection setup and to which can be added a new field for indicating the DCCM operating mode. MS2 transmits the MS RAC message indicating the DCCM operating mode to the serving GPRS support node SGSN (step 2). Thus, this embodiment of the invention preferably utilizes the existing signaling processes, and no new signaling messages are needed. So the signaling load of the network does not preferably grow, either.

As a part of the GPRS Attach process, the serving GPRS support node SGSN transmits to the mobile station MS2 a paging message that passes through network elements (PCU, BSC, BTS) to the mobile station MS2. In order that the radio network could transmit the paging message on a correct paging channel (either PCH or PPCH), the radio network should have the information which paging channel to use. According to one preferred embodiment, this can be implemented such that the serving GPRS support node SGSN attaches the field, which indicates the DCCM operating mode and is received in the MS RAC message, to a paging message to be forwarded to the radio network, more precisely, to a packet control unit PCU (step 3). Having received the information on the correct paging channel, the packet control unit further controls the base station controller BSC and the base transceiver station BTS of the cell in question to use said paging channel (step 4).

Alternatively, the above-described paging channel indication to the radio network (step 3) can also be implemented such that the serving GPRS support node SGSN transmits a prior art paging message to the packet control unit PCU, in response to which the packet control unit inquires the serving GPRS support node about the paging channel used by the mobile station MS, each time separately if necessary. This procedure slows down the transmission of paging messages to the mobile stations, though, and increases signaling load at the Gb interface between the serving GPRS support node SGSN and the packet control unit PCU. A further alternative for this implementation is to transmit all paging messages on both paging channels (PCH and PCCH), which in turn consumes signaling capacity particularly at the air interface Um between the base transceiver station BTS and the mobile station MS.

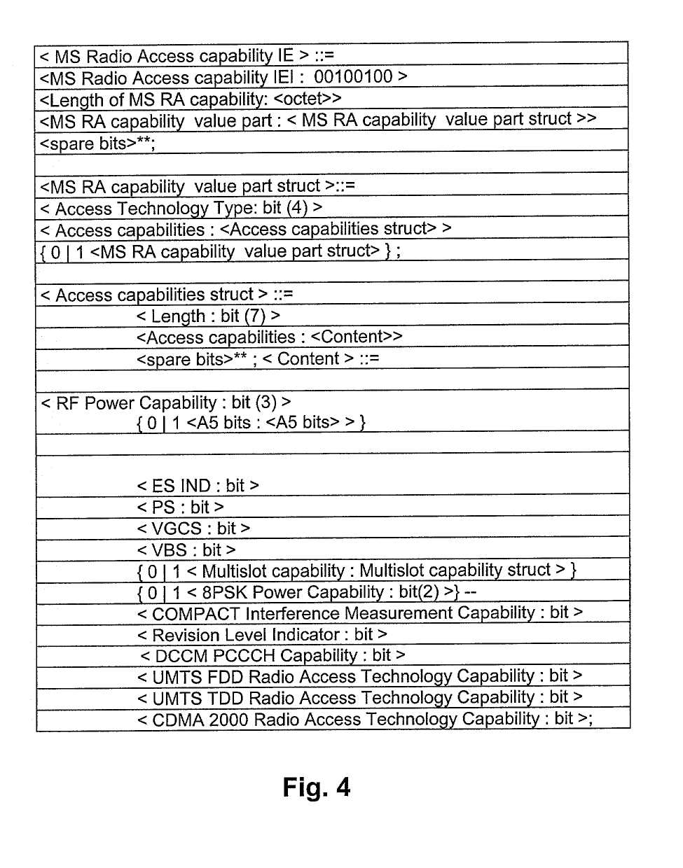

According to one preferred embodiment of the invention, the DCCM compatibility of the mobile station can be indicated to the network by means of the MS RAC message of FIG. 4. The task of the MS RAC message is to convey information to the radio network about the radio interface characteristics of the mobile station, which information the network utilizes for defining radio interface parameters for the mobile station. The MS RAC message can now be modified such that it comprises a DCCM operating mode field, which is indicated to the serving GPRS support node SGSN. In FIG. 4, this field is determined by the term “DCCM PCCCH Capability”, but it is apparent that any other term can also be used for this field. The length of the field is preferably set to be one bit, and when the mobile station uses this field to indicate that it is able to retrieve from the above SI13 message also the description of the PBCCH channel in the DCCM cells and to seek to the PBCCH channel, the value of said bit is set to one. Thus, the serving GPRS support node SGSN can give instructions to the packet control unit PCU to transmit the paging messages on the PCCH channel. Otherwise, the field can be preferably omitted from the MS RAC message, or the value of the bit can be set to zero. In both cases the serving GPRS support node SGSN can conclude that the mobile station remains on the CCCH channel and the paging messages are sent on the PCH channel. Advantageously, no new messages are thus needed for performing the DCCM indication, but the existing signaling and messages can be utilized, and consequently the signaling load of the network does not increase. The rest of the MS RAC message contents is described in greater detail in the document 3GPP TS 24.008, V3. 7.0, paragraph 10.5.5.12a “MS Radio Access Capability”, but this is not relevant to the implementation of the invention.

According to an alternative embodiment of the invention, in all cells, the parameters required for the GPRS connection are transmitted to DCCM mobile stations from the network on a circuit-switched broadcast control channel BCCH. This is advantageously achieved in such a manner that if the cell uses the packet broadcast control channel PBCCH, a field where the necessary CCCH channel parameters are transmitted and which the DCCM mobile stations are able to decode is attached to a parameter transmission message, preferably to SI13 message, to be transmitted on the circuit-switched broadcast control channel BCCH. The mobile stations that support only the packet broadcast control channel PBCCH ignore this field. Thus, both the GPRS mobile stations supporting the DCCM function and the GPRS mobile stations not operating on the PBCCH channels to be built in the network receive the CCCH channel parameters, necessary for using the GPRS service, on the BCCH channel. Correspondingly, the GPRS mobile stations to be developed in the future and operating according to the standard will perform broadcast control channel reception only on the PBCCH channel and will obtain the PCCCH parameters therefrom.

In such a case when the network does not support transmission on the PBCCH/PCCCH channels, all mobile stations receive the parameters necessary for using the GPRS service on the BCCH channel, irrespective of which channels the mobile stations support. On the other hand, if the network supports transmission also on the PBCCH/PCCCH channels, the mobile stations supporting the PBCCH/PCCCH channels operate according to the default and receive the necessary GPRS parameters on these channels. The DCCM mobile stations, in turn, are able to decode the extra field in said SI13 message and obtain thereby the CCCH channel parameters necessary for the GPRS service.

Also in this alternative embodiment, the allocation of broadcast control channels should be taken into account for defining other control channels. Also in this alternative, the GPRS mobile stations must be able to indicate to the network which common channel, CCCH or PCCCH, it uses for receiving paging messages. This can take place in the above-described manner by the MS RAC message to be transmitted in connection with the GPRS Attach process, however, such that all mobile stations indicate in the field, comprised by the MS RAC message, such as the above-described “DCCM PCCCH Capability” field, either one of the bit values 1 or 0. This bit value lets the serving GPRS support node SGSN know, which control channel (CCCH or PCCCH), and thereby paging channel (PCH or PPCH) the mobile station is set to listen. The serving GPRS support node SGSN can thus give instructions to the packet control unit PCU, for instance, to transmit paging messages either on PCH or PCCH, depending on the case.

Despite the above-described arrangement for indicating a correct paging channel to the radio network, it is also possible that the network supports only packet-switched PPCH paging channels or circuit-switched PCH paging channels, but is unable to support both paging channels simultaneously such that the network could interpret a correct paging channel for each mobile station. On the other hand, it is also possible that the mobile station is capable of reception only on the circuit-switched CCCH channels, which has a drawback that when the network tries to transmit GPRS parameters on the PBCCH channel or a PPCH paging message on the PCCCH channel, the mobile station is unable to decode them, and consequently it falls into an error state both regarding the GPRS service and the circuit-switched GSM voice services.

In order that the mobile station could use at least the voice services, the above problem can be solved according to one alternative embodiment of the invention in such a manner that the mobile station receives from the network an indication that said network supports both paging channels but is unable to send paging messages simultaneously on both channels, and therefore is also unable to define a correct paging channel for each mobile station. In other words, in this case the network assumes that all GPRS mobile stations operate on the PBCCHIPCCCH channels and all circuit-switched GSM mobile stations, which do not support the GPRS, operate on the BCCH/CCCH channels.

In response to this indication, the GPRS mobile station that does not support the PBCCHIPCCCH channels changes its characteristics by temporarily cancelling its GPRS functions, whereby it temporarily becomes an ordinary, circuit-switched GSM mobile station. The mobile station indicates this back to the network, and as a consequence the network will not transmit GPRS parameters to the mobile station in question. Thus, said mobile station may continue operating in connection with circuit-switched voice services. This will advantageously facilitate the implementation of both networks and mobile stations at a stage when PBCCH/PCCCH channels will be introduced to the GPRS networks.

It is apparent to a person skilled in the art that as technology progresses the basic idea of the invention can be implemented in a variety of ways. Thus, the invention and its embodiments are not restricted to the above-described examples, but they may vary within the scope of the claims.

1. A method for transmitting connection setup parameters of a packet data network on broadcast control channels in a telecommunication system which comprises at least one cell which uses a circuit-switched broadcast/common control channel (BCCH/CCCH) and a packet-switched broadcast/common control channel (PBCCH/PCCCH), and at least one mobile station which supports the packet data network and is arranged to listen to at least one of said broadcast/common control channels, comprising:
transmitting the connection setup parameters of the packet data network to mobile stations in said cell on both broadcast control channels in response to the fact that the cell supports the transmission of the connection setup parameters of the data packet network on both the circuit-switched broadcast control channel and the packet-switched broadcast control channel;
transmitting a DCCM indication from the mobile station to the packet data network in response to the fact that said mobile station is able to receive control messages on both of said common control channels; and
controlling said telecommunication system to transmit control messages to said mobile station on one of said common control channels.

2. The method of claim 1, wherein
said packet data network is a GPRS system, whereby
said DCCM indication is transmitted from the mobile station to the serving GPRS support node of the packet data network in an MS RAC message.

3. The method of claim 2, further comprising
controlling said telecommunication system to transmit the control messages from the serving GPRS support node to said mobile station, which transmitted the DCCM indication, on a packet-switched common control channel.

4. A method for transmitting connection setup parameters of a packet data network on broadcast control channels in a telecommunication system which comprises at least one cell which uses a circuit-switched broadcast/common control channel (BCCH/CCCH) and a packet-switched broadcast/common control channel (PBCCH/PCCCH), and at least one mobile station which supports the packet data network and is arranged to listen to at least one of said broadcast/common control channels, comprising:
transmitting the connection setup parameters of the packet data network to a mobile station in said cell on the circuit-switched broadcast control channel, in response to the fact that said mobile station is able to receive control messages on both of said common control channels;
transmitting a DCCM indication from said mobile station to the packet data network; and
controlling said telecommunication system to transmit control messages to said mobile station on the circuit-switched common control channel.

5. The method of claim 4, wherein
said packet data network is a GPRS system, whereby
said DCCM indication is transmitted from the mobile station to the serving GPRS support node of the packet data network in an MS RAC message.

6. The method of claim 5, further comprising:
controlling said telecommunication system to transmit the control messages from the serving GPRS support node to said mobile station, which transmitted the DCCM indication, on a packet-switched common control channel.

7. A method for transmitting connection setup parameters of a packet data network on broadcast control channels in a telecommunication system which comprises at least one cell which uses a circuit-switched broadcast/common control channel (BCCHICCCH) and a packet-switched broadcast/common control channel (PBCCH/PCCCH), and at least one mobile station which supports the packet data network and is arranged to listen to at least one of said broadcast/common control channels, comprising:
transmitting an indication to the mobile stations in said cell that the cell supports transmission of the packet data network's connection setup parameters on either the circuit-switched broadcast control channel or the packet-switched common control channel;
in response to the mobile station not supporting reception of the connection setup parameters on the packet-switched broadcast/common control channel, the characteristics of said mobile station are temporarily changed such that the mobile station is arranged to receive only circuit-switched services;
transmitting an indication of said change in the characteristics from said mobile station to the packet data network; and
controlling said telecommunication network to temporarily provide said mobile station with circuit-switched services only.

8. A telecommunication system which comprises a packet data network and at least one cell which uses a circuit-switched broadcast control channel (BCCH) and a packet-switched broadcast control channel (PBCCH), and at least one mobile station which supports the packet data network and is arranged to listen to at least one of said broadcast control channels, in which telecommunication system the connection setup parameters of the packet data network are arranged to be transmitted on broadcast control channels, wherein
the connection setup parameters of the packet data network are arranged to be transmitted to mobile stations in said cell on both broadcast control channels in response to the fact that the cell supports transmitting the connection setup parameters of the packet data network on both the circuit-switched broadcast control channel and the packet-switched broadcast control channel,
the mobile station is arranged to transmit a DCCM indication to the packet data network in response to said mobile station being able to receive control messages on both of said common control channels, and
in response to said DCCM indication, said telecommunication system is arranged to transmit control messages to said mobile station on one of said common control channels.

9. The telecommunication system of claim 8, wherein
said packet data network is a GPRS system, and
said DCCM indication from the mobile station to the serving GPRS support node is arranged to be indicated in an MS RAC message.

10. The telecommunication system of claim 9, wherein
the serving GPRS support node is arranged to control said telecommunication system to transmit the control messages to said mobile station, which transmitted the DCCM indication, on the packet-switched common control channel.

11. A telecommunication system which comprises a packet data network and at least one cell which uses a circuit-switched broadcast control channel (BCCH) and a packet-switched broadcast control channel (PBCCH), and at least one mobile station which supports the packet data network and is arranged to listen to at least one of said broadcast control channels, in which telecommunication system the connection setup parameters of the packet data network are arranged to be transmitted on broadcast control channels, wherein
the connection setup parameters of the packet data network are arranged to be transmitted to the mobile stations in said cell on a circuit-switched broadcast control channel, in response to the fact that said mobile station is able to receive control messages on both of said common control channels,
the mobile station is arranged to transmit a DCCM indication to the packet data network, and
in response to said DCCM indication, said telecommunication system is arranged to transmit control messages to said mobile station on the circuit-switched common control channel.

12. The telecommunication system of claim 11, wherein
said packet data network is a GPRS system, and
said DCCM indication from the mobile station to the serving GPRS support node is arranged to be indicated in an MS RAC message.

13. The telecommunication system of claim 12, wherein
the serving GPRS support node is arranged to control said telecommunication system to transmit the control messages to said mobile station, which transmitted the DCCM indication, on the packet-switched common control channel.

14. A mobile station supporting a packet data network, which mobile station is arranged to support broadcast reception on a circuit-switched broadcast/common control channel (BCCH/CCCH) and a packet-switched broadcast/common control channel (PBCCH/PCCCH) and which is arranged to listen to at least one of said broadcast/common control channels, wherein
the mobile station is arranged to decode the connection setup parameters of the packet data network from the message transmitted by the telecommunication system, in which message the cell of the mobile station indicates that it supports the transmission of the connection setup parameters of the packet data network on both the circuit-switched broadcast control channel and the packet-switched broadcast control channel, and
the mobile station is arranged to listen to the broadcast control channel indicated by said connection setup parameters.

15. The mobile station of claim 14, wherein
the mobile station is arranged to transmit a DCCM indication to the packet data network in response to said mobile station being able to receive control messages on both of said common control channels, and
the mobile station is arranged to receive control messages that the telecommunication system transmits on one of said common control channels.

16. The mobile station of claim 14, wherein
said packet data network is a GPRS system, whereby
the mobile station is arranged to transmit said DCCM indication to the serving GPRS support node of the packet data network in an MS RAC message.

17. A mobile station supporting a packet data network, which mobile station is arranged to support broadcast reception on a circuit-switched broadcast/common control channel (BCCHICCCH), wherein
the mobile station is arranged to receive a message from the network, in which message the cell of the mobile station indicates that it supports the transmission of the connection setup parameters of the packet data network on either the circuit-switched broadcast control channel or the packet-switched broadcast control channel,
in response to said message, the mobile station is arranged to change its characteristics temporarily such that the mobile station will be arranged to receive only circuit-switched services, and
the mobile station is arranged to transmit an indication of said change in the characteristics to the network.
